(19) United States
(12) Patent Application Publication
(10) Pub. No.: US 2021/0303248 A1
(43) Pub. Date: Sep. 30, 2021

(54) DISPLAY DEVICE AND CONTROL METHOD FOR DISPLAY DEVICE

(71) Applicant: Panasonic Intellectual Property Management Co., Ltd., Osaka (JP)

(72) Inventors: Jun NAKAI, Kanagawa Ken (JP); Takashi OKOHIRA, Kanagawa Ken (JP)

(73) Assignee: Panasonic Intellectual Property Management Co., Ltd., Osaka (JP)

(21) Appl. No.: 17/211,514

(22) Filed: Mar. 24, 2021

(30) Foreign Application Priority Data
Mar. 27, 2020 (JP) 2020-059009

(51) Int. Cl. G06F 3/147; G06F 3/041; G06F 3/0481; B60R 1/00

(52) U.S. Cl. CPC G06F 3/147; G06F 3/0412; G06F 3/044; G06F 3/04817; B60R 1/00; G06F 3/04166

(57) ABSTRACT

A display device includes a panel device and a hardware processor. The hardware processor controls the panel device in a first mode for displaying first image data, and controls the panel device in a second mode for displaying second image data in a case that an abnormality in display of the first image data is detected. In the second mode, the hardware processor: reads out the second image data from a memory of the display device; displays the second image data on the panel device in place of the first image data; determines presence or absence of a touch on the panel device based on a touch detection signal acquired from the panel device; and outputs, to the external system, an execution command to execute predetermined processing in response to determining that the touch on the panel device is present.

### CROSS-REFERENCE TO RELATED APPLICATIONS

This application is based upon and claims the benefit of priority from Japanese Patent Application No. 2020-059009, filed on Mar. 27, 2020, the entire contents of which are incorporated herein by reference.

### FIELD

The present disclosure relates to a display device and a control method for the display device.

### BACKGROUND

In the related art, there is known an onboard system including a plurality of display devices, a video output device that outputs image information to the display devices, and a vehicle signal generation device. For such a type of onboard system, there is known a technique in which, when any of the display devices break down, the vehicle signal generation device notifies a normal display device of breakdown of the display device, and causes the normal display device to display minimum security information required for driving (for example, Japanese Patent Application Laid-open No. 2018-021989).

However, in the related art, it is assumed that a plurality of display devices are installed. Thus, in a case that only one display device is installed and abnormality in image displayed on this display device is detected, an occupant may be embarrassed because the security information cannot be displayed.

### SUMMARY

A display device according to the present disclosure includes: a panel device including a plurality of electrodes to perform image display and touch detection; a hardware processor that controls the panel device in a first mode for displaying first image data, and controls the panel device in a second mode for displaying second image data in a case that an abnormality in display of the first image data is detected; and a memory that stores the second image data. In the first mode, the hardware processor is configured to: acquire the first image data from an external system; display the first image data on the panel device; calculate a touch position on the panel device based on a touch detection signal acquired from the panel device; and output the touch position to the external system. In the second mode, the hardware processor is configured to: read out the second image data from the memory, display the second image data on the panel device in place of the first image data, determine presence or absence of a touch on the panel device based on a touch detection signal acquired from the panel device, and output, to the external system, an execution command to execute predetermined processing in response to determining that the touch on the panel device is present.

### BRIEF DESCRIPTION OF THE DRAWINGS

FIG. 1 is a block diagram illustrating a configuration example of a display system according to a first embodiment;

FIG. 2 is a diagram illustrating an example of mode information;

FIG. 3 is a sequence diagram illustrating an operation example of the display system in a normal mode;

FIG. 4 is a sequence diagram illustrating an operation example of the display system in a specific mode;

FIG. 5 is a diagram illustrating a screen example of second image data on a panel unit;

FIG. 6 is a diagram illustrating a screen example of the second image data on the panel unit;

FIG. 7 is a diagram illustrating a division example of a screen;

FIG. 8 is a diagram illustrating a division example of the screen;

FIG. 9 is a diagram illustrating a division example of the screen;

FIG. 10 is a sequence diagram illustrating an operation example of a display system according to a second embodiment;

FIG. 11 is a block diagram illustrating a configuration example of a display system according to a third embodiment;

FIG. 12 is a sequence diagram illustrating an operation example of the display system in a specific mode according to the third embodiment;

FIG. 13 is a diagram illustrating a configuration example of an onboard device according to a modification;

FIG. 14 is a diagram illustrating a configuration example of a display system according to the modification; and

FIG. 15 is a diagram illustrating a screen example according to the modification.

### DETAILED DESCRIPTION

The following describes embodiments of a display device and a control method for the display device according to the present disclosure with reference to the attached drawings.

The following successively describes a first embodiment to a third embodiment. The first and the second embodiments describe a case that the display device is an in-cell type, and the third embodiment describes a case that the display device is an out-cell type.

### First Embodiment

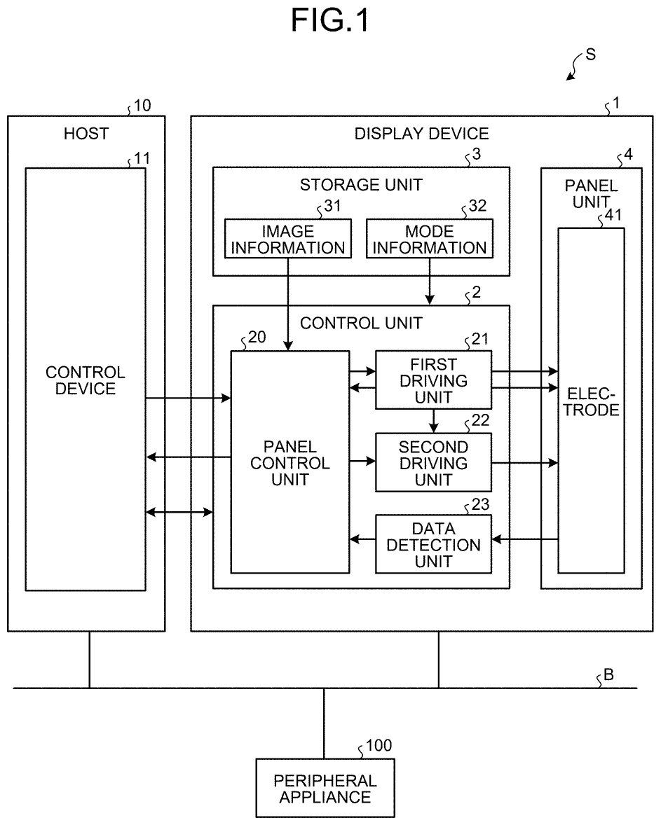

The following describes a display system S including a display device 1 according to a first embodiment with reference to FIG. 1. FIG. 1 is a block diagram illustrating a configuration example of the display system S according to the first embodiment. The display system S is a system mounted on a vehicle such as an automobile, and connected to various kinds of peripheral appliance 100 via a bus B such as a Controller Area Network (CAN). The display device 1, a host (a host device) 10, and the peripheral appliance 100 may be connected to each other in a wireless manner, or in a wired manner. In a case that the connection is made in a wireless manner, wireless communication can be performed by using an Ultra-Wide Band (UWB) used for the fifth-generation mobile communication system (5G) and the like, or another frequency band.

The peripheral appliance 100 includes a camera, a sensor that detects information about vehicle such as a vehicle speed sensor, an Electronic Control Unit (ECU) related to control of a vehicle, and the like. The peripheral appliance 100 outputs various kinds of information to the display system S, and performs each piece of processing in accordance with a command from the display system S.

In the following description, each of the peripheral appliance 100 and the host 10 may be referred to as an onboard system (or an external system), or the peripheral appliance 100 and the host 10 may be collectively referred to as an onboard system (or an external system). In other words, appliances other than the display device 1 may be collectively referred to as an onboard system (or an external system) in some cases.

The display system S includes the display device 1 and the host 10. The host 10 includes, for example, a control device 11. The control device 11 is, for example, a CPU, and is also called a host CPU. The control device 11 outputs image data (first image data) and control data to the display device 1, and controls the display device 1.

The first image data is image data generated by the control device 11, or image data input from a peripheral appliance. The first image data is, for example, image data related to navigation, or image data related to entertainment such as a television.

The control data is data for controlling the display device 1. Specifically, the control data includes information such as a display timing for the first image data and a timing for touch detection.

The display device 1 includes a control unit (a hardware processor) 2, a storage unit (a memory) 3, and a panel unit (a panel device) 4. The control unit 2 includes a panel control unit 20, a first driving unit 21, a second driving unit 22, and a data detection unit 23. The storage unit 3 stores image information 31 and mode information 32.

The panel unit 4 is used as, for example, a center display in a compartment on which a screen related to navigation and the like are displayed. The panel unit 4 is an in-cell type liquid crystal display device using an In Plane Switching (IPS) scheme, and can perform not only image display but also touch detection.

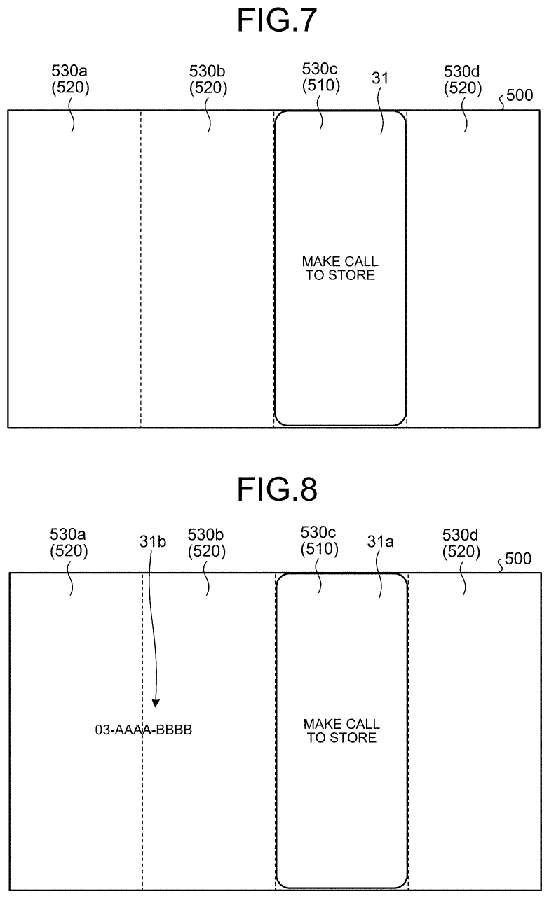

Specifically, the panel unit 4 includes a plurality of electrodes 41 that are shared to perform image display and touch detection. More specifically, the panel unit 4 as an in-cell type touch display divides one unit frame period into a plurality of display periods and a plurality of touch detection periods in a time division manner, and alternately arranges the respective periods. The panel unit 4 divides one screen into a plurality of touch detection regions 530a to 530d (refer to FIG. 7 described later), and detects a touch within the touch detection region different for each touch detection period to perform touch detection for one screen in the unit frame period. Each of the touch detection regions is also called a scan block.

The panel unit 4 can employ, for example, what is called an electrostatic capacitance scheme in which the electrode 41 is configured as a capacitor to perform touch detection based on a variation in capacitance of the capacitor. The panel unit 4 using the electrostatic capacitance scheme may be configured as a self-capacitance scheme, or as a mutual capacitance scheme.

In this case, the display device 1 has a hardware configuration in which a central processing unit (CPU), a read only memory (ROM), a random access memory (RAM), an I/F, and the like are connected to each other via a bus, using a normal computer.

The CPU is an arithmetic device (a hardware processor) that controls the display device 1 according to the embodiment, and executes functions (the units 20 to 23 in FIG. 1) of the control unit 2. Details about the respective functions (the units 20 to 23) of the control unit 2 will be described later.

The ROM corresponds to the storage unit 3, and stores a computer program and the like for implementing processing performed by the CPU. The RAM corresponds to the storage unit 3, and stores data required for processing performed by the CPU. The I/F is an interface for transmitting and receiving data.

The computer program for performing various kinds of processing to be executed by the display device 1 according to the embodiment is embedded and provided in the ROM and the like. The computer program to be executed by the display device 1 according to the embodiment may also be stored and provided in a computer-readable storage medium (for example, a flash memory) as a file in a format of being able to be installed in or executed by the display device 1.

As illustrated in FIG. 1, the storage unit 3 stores the image information 31 and the mode information 32. The image information 31 is image data (second image data) that is stored in the storage unit 3 in advance. The image information 31 is, specifically, an On-Screen Display (OSD) data. The image information 31 includes icon image data 31a (refer to FIG. 6), text data 31b related to the icon image data 31a, and the like. Details thereof will be described later.

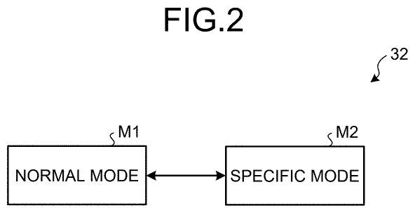

The mode information 32 is information including a computer program related to an operation mode of the control unit 2. FIG. 2 is a diagram illustrating an example of the mode information 32. FIG. 2 schematically illustrates the mode information 32.

As illustrated in FIG. 2, the mode information 32 includes two operation modes, that is, a normal mode M1 (first mode) and a specific mode M2 (second mode). The control unit 2 selects one of the operation modes based on presence or absence of an abnormality related to display of the first image data acquired from the control device 11. Examples of the abnormality related to display of the first image data include an abnormality of a signal indicating the first image data output from the control device 11, a communication abnormality between the host 10 and the display device 1, a display abnormality of the panel unit 4, and so on.

Processing of detecting such abnormality related to display of the first image data may be performed by the control unit 2 of the display device 3, or may be performed by another external device. The display abnormality of the panel unit 4 may be a partial abnormality of a display region of the panel unit 4, or may be an abnormality of the entire region. The display abnormality of the panel unit 4 can be detected based on, for example, a fault in a signal line connected to the electrode 41, a circuit fault in the panel control unit 20, and the like.

The first embodiment describes an operation in a case that the abnormality related to display of the first image data is an abnormality in a signal indicating the first image data output from the control device 11 or a display abnormality of the panel unit 4, and the second embodiment describes an operation in a case that the abnormality related to display of the first image data is a communication abnormality (interruption) between the host 10 and the display device 1. Thus, in the first embodiment, communication between the host 10 and the display device 1 is assumed to be normal.

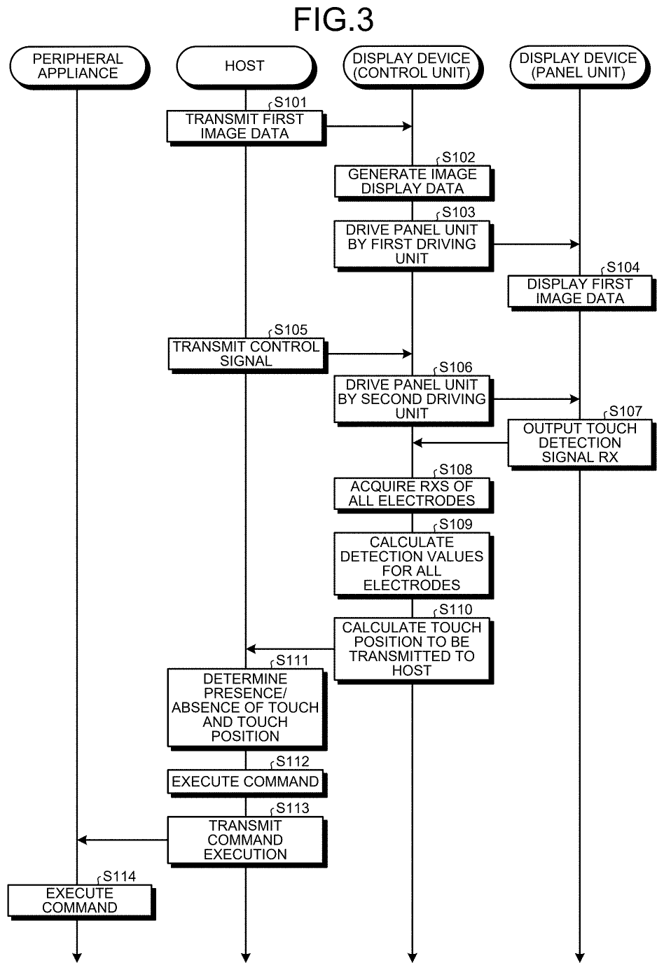

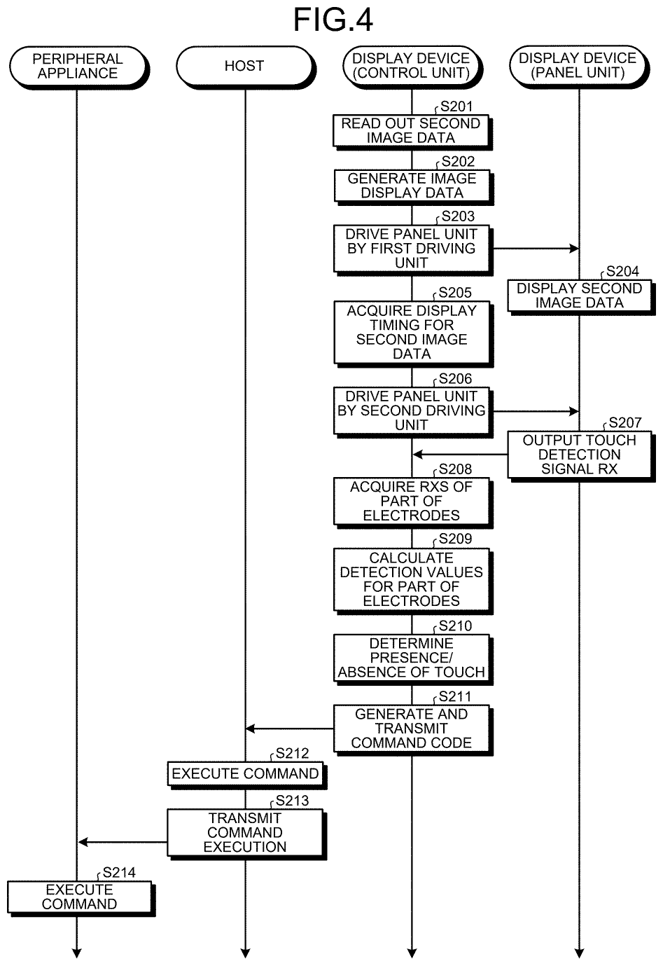

In a case that the abnormality related to display of the first image data is not detected, the control unit 2 selects the normal mode M1 as the operation mode, and controls the panel unit 4 in the normal mode M1. In a case that the abnormality related to display of the first image data is detected, the control unit 2 selects the specific mode M2 as the operation mode, and controls the panel unit 4 in the specific mode M2. An operation sequence in the normal mode M1 and an operation sequence in the specific mode M2 will be described later with reference to FIG. 3 and FIG. 4.

The following describes the respective functions (the units 20 to 23) of the control unit 2.

The panel control unit 20 controls image display and touch detection to be performed by the panel unit 4, in accordance with various kinds of data acquired from the control device 11 of the host 4. Specifically, the panel control unit 20 controls a drive timing of each of the first driving unit 21 and the second driving unit 22, a data detection timing (a touch detection timing) by the data detection unit 23, and the like.

Although details will be described later, in the normal mode M1, the panel control unit 20 acquires the first image data from the control device 11 to be displayed on the panel unit 4. In the specific mode M2, the panel control unit 20 reads out the second image data from the image information 31 stored in the storage unit 3 of the display device 1 and displays it on the panel unit 4.

The panel control unit 20 stores, in the storage unit 3, information about a display position of the second image data in the display region of the panel unit 4. The panel control unit 20 may notify the data detection unit 23 of the information about the display position of the second image data.

The first driving unit 21 generates a reference clock signal in accordance with control by the panel control unit 20. Subsequently, the first driving unit 21 acquires the image data (the first image data or the second image data) from the panel control unit 20, and converts the first image data into a video signal. The video signal is synchronized with the reference clock signal. The first driving unit 21 outputs the video signal to the electrode 41 of the panel unit 4 at a drive timing (in a display period) notified from the panel control unit 20 to drive the electrode 41 of the panel unit 4 in the display period for displaying the image data.

The first driving unit 21 outputs the generated reference clock signal to the second driving unit 22.

The second driving unit 22 generates a touch drive signal TX based on a reference voltage as a fixed voltage that is determined in advance in accordance with control by the panel control unit 20. The touch drive signal TX is synchronized with the reference clock signal. The touch drive signal TX may be a rectangular wave, or may be a sinusoidal wave.

The second driving unit 22 outputs the touch drive signal TX to the electrode 41 of the panel unit 4 in the touch detection period, and outputs a signal of the reference voltage to the electrode 41 of the panel unit 4 in the display period to drive the electrode 41 of the panel unit 4 for touch detection in the touch detection period.

The data detection unit 23 receives a touch detection signal RX based on the touch drive signal TX from each of the electrodes 41 to which the touch drive signal TX is supplied, and calculates a detection value based on the touch detection signal RX. The detection value is output to the panel control unit 20, and used for touch determination by the panel control unit 20.

Specifically, the data detection unit 23 integrates touch detection signals RX received from the respective electrodes 41, and calculates a difference between an integral value and a reference value as the detection value for each pulse timing of the touch drive signal TX. For example, in a case that touch drive signals TX of three pulses are output to the respective electrodes 41 in one touch detection period, three touch detection signals RX are obtained from the respective electrodes 41 in the one touch detection period, so that the number of detection values (number of integral values) is three.

That is, for the touch detection signal RX received from one electrode 41 in one touch detection period, obtained are the detection values the number of which is equal to the number of pulses of the touch drive signal TX in the one touch detection period. In other words, each of the detection values is a difference value between capacitance of the electrode 41 and reference capacitance. As a variation amount of the capacitance of the electrode 41 due to a touch is increased, the detection value becomes larger. If there is no touch and the variation amount of the capacitance of the electrode 41 is zero, the detection value is zero.

In a case that the operation mode is the normal mode, the data detection unit 23 receives the touch detection signals RX from all the electrodes 41, and calculates the detection values for all the electrodes 41. On the other hand, in a case that the operation mode is the specific mode, the data detection unit 23 receives the touch detection signals RX from part of the electrodes 41 corresponding to the display position of the second image data, and calculates the detection values for the part of the electrodes 41.

The second image data may be displayed in units of a scan block, and the detection values for part of the electrodes 41 may be calculated in units of a scan block. The data detection unit 23 may receive the touch detection signals RX from all the electrodes 41, and calculate the detection values for only part of the electrodes 41 corresponding to the display position of the second image data.

The panel control unit 20 acquires the detection values from the second driving unit 22, and calculates the sum total of the detection values obtained from one touch detection period. That is, the panel control unit 20 calculates the sum total of the detection values for each touch detection period.

The panel control unit 20 then compares the calculated sum total of the detection values with a predetermined touch detection threshold, and if the sum total of the detection values is equal to or larger than the touch detection threshold, determines that there is a touch at a position of the corresponding electrode 41.

The panel control unit 20 also detects a touch position in the display region of the panel unit 4 based on the position of the electrode 41 at which it is determined that there is a touch. The panel control unit 20 derives coordinate data of the touch position based on information about the detected touch position, and outputs the coordinate data to the control device 11.

The panel control unit 20 detects presence or absence of a touch on the panel unit 4 and the touch position on the panel unit 4 based on the sum total of the detection values in a case that the operation mode is the normal mode. However, in a case that the operation mode is the specific mode, detects only presence/absence of a touch on the panel unit 4 based on the sum total of the detection values. That is, the panel control unit 20 does not detect the touch position in a case that the operation mode is the specific mode.

In response to determining that there is a touch on the panel unit 4 in the specific mode, the panel control unit 20 outputs, to the host 10, a command code assigned to the second image data.

Next, the following describes an operation example of the display system S in each of the operation modes including the normal mode M1 and the specific mode M2 with reference to FIG. 3 and FIG. 4. FIG. 3 is a sequence diagram illustrating an operation example of the display system S in the normal mode M1. FIG. 4 is a sequence diagram illustrating an operation example of the display system S in the specific mode M2.

First, the following describes the operation example of the display system S in the normal mode M1 with reference to FIG. 3. As illustrated in FIG. 3, first, the host 10 generates the first image data to be transmitted to the display device 1 (Step S101).

Subsequently, the panel control unit 20 of the display device 1 receives the first image data, and generates image display data to be displayed on the panel unit 4 based on the first image data (Step S102).

Subsequently, the first driving unit 21 acquires the image display data from the panel control unit 20, and drives the electrode 41 of the panel unit 4 by a video signal based on the image display data (Step S103) to display the first image data in the display region of the panel unit 4 (Step S104).

The host 10 transmits a control signal for controlling a touch function to the display device 1 in accordance with transmission of the first image data (Step S105). The panel control unit 20 controls the second driving unit 22 in accordance with a display timing for the first image data based on the received control signal (control data) to drive the electrode of the panel unit 4 (Step S106). Specifically, the second driving unit 22 generates the touch drive signal TX in accordance with control by the panel control unit 20, and supplies the touch drive signal TX to each of the electrodes 41. With this processing, touch detection is enabled to be performed while displaying the first image data.

The panel unit 4 then outputs, to the data detection unit 23, the touch detection signal RX corresponding to a user's operation on the electrode 41 to which the touch drive signal TX is supplied (Step S107). Subsequently, the data detection unit 23 acquires the touch detection signals RX from all the electrodes 41 in the panel unit 4 (Step S108). Subsequently, the data detection unit 23 calculates the detection value for each of the electrodes 41 based on the touch detection signal RX (Step S109). Subsequently, the panel control unit 20 determines presence or absence of a touch on the panel unit 4 and calculates a touch position on the panel unit 4 based on the detection value, and transmits information about the presence/absence of a touch and the touch position to the host 10 (Step S110). Specifically, the panel control unit 20 detects, as the touch position (there is a touch), a position corresponding to the electrode 41 the detection value for which is equal to or larger than the threshold.

Subsequently, the host 10 decides presence or absence of a touch on a specific position and the touch position in the first image data, based on the received information about the touch position (Step S111). The specific position is a region of a display button and the like in the first image data, and is a region that can be operated by an occupant as a user.

Subsequently, the host 10 executes a command based on a command code assigned to the touched specific position (Step S112). In a case that the command code includes a command to execute the peripheral appliance 100, the host 10 transmits, to the corresponding peripheral appliance 100, command execution indicating to execute the command (Step S113). The peripheral appliance 100 then executes the command based on the command execution (Step S114).

Next, the following describes an operation example of the display system S in the specific mode M2 with reference to FIG. 4. In FIG. 4, it is assumed that the mode has been switched to the specific mode M2 before Step S201. As illustrated in FIG. 4, first, the panel control unit 20 reads out the image information 31 as the second image data from the storage unit 3 (Step S201). That is, in the specific mode M2, the second image data, which has been stored in the memory (the storage unit 3) of the display device 1, is read out without acquiring the first image data from the host 10.

Subsequently, the panel control unit 20 of the display device 1 generates image display data to be displayed on the panel unit 4 based on the second image data (Step S202).

Subsequently, the first driving unit 21 acquires the image display data from the panel control unit 20, and drives the electrode 41 of the panel unit 4 by the video signal based on the image display data (Step S203) to display the second image data in the display region of the panel unit 4 (Step S204).

The panel control unit 20 acquires a display timing for the second image data (Step S205), and controls the second driving unit 22 in accordance with the display timing to drive the electrode of the panel unit 4 (Step S206). That is, the second driving unit 22 generates the touch drive signal TX in accordance with control by the panel control unit 20, and supplies the touch drive signal TX to each of the electrodes 41. With this processing, touch detection is enabled to be performed while displaying the second image data.

The panel unit 4 then outputs, to the data detection unit 23, the touch detection signal RX corresponding to a user's operation on the electrode 41 to which the touch drive signal TX is supplied (Step S207). Subsequently, the data detection unit 23 acquires the touch detection signals RX from part of the electrodes 41 corresponding to the display position of the second image data in the display region of the panel unit 4 (Step S208).

Subsequently, the data detection unit 23 calculates the detection value for each of the part of the electrodes 41 based on the touch detection signal RX (Step S209). Subsequently, the panel control unit 20 determines presence or absence of a touch on the panel unit 4 based on the detection value (Step S210). Specifically, the panel control unit 20 determines that a touch on the panel unit 4 is performed (there is a touch) in a case that the detection value becomes equal to or larger than the threshold. In the specific mode, detection of presence/absence of a touch is performed, whereas calculation of the touch position is not performed.

Subsequently, in a case of determining that a touch is performed, the panel control unit 20 transmits the command code assigned to the second image data to the host 10 (Step S211). The host 10 then executes the command based on the received command code (Step S212). In a case that the command code includes a command to execute the peripheral appliance 100, the host 10 transmits, to the corresponding peripheral appliance 100, command execution indicating to execute the command (Step S213). The peripheral appliance 100 then executes the command based on the command execution (Step S214).

In this way, even in a case that a display abnormality of the first image data occurs, the display device 1 according to the first embodiment can display the second image data stored in advance, receives a touch on the panel unit 4 by the user, and commands to perform processing to the host 4 and/or the peripheral appliance 100. With this processing, even in a case that an image abnormality occurs in the display device 1, the occupant can perform an operation for performing predetermined processing in the specific mode, so that the occupant can be prevented from being embarrassed with the abnormality of the display device 1. That is, with the control method for the display device 1 according to the embodiment, a sense of security can be given to the occupant even in a case that an image abnormality occurs in the display device 1.

In a case that an abnormality occurs in the first image data, the display device 1 can display the second image data at an optional display position of the panel unit 4. However, in a case that an abnormality occurs in the display region at a specific position due to a fault of the panel unit 4 (for example, a fault of the electrode 41), the display device 1 displays the second image data at a display position other than the specific position.

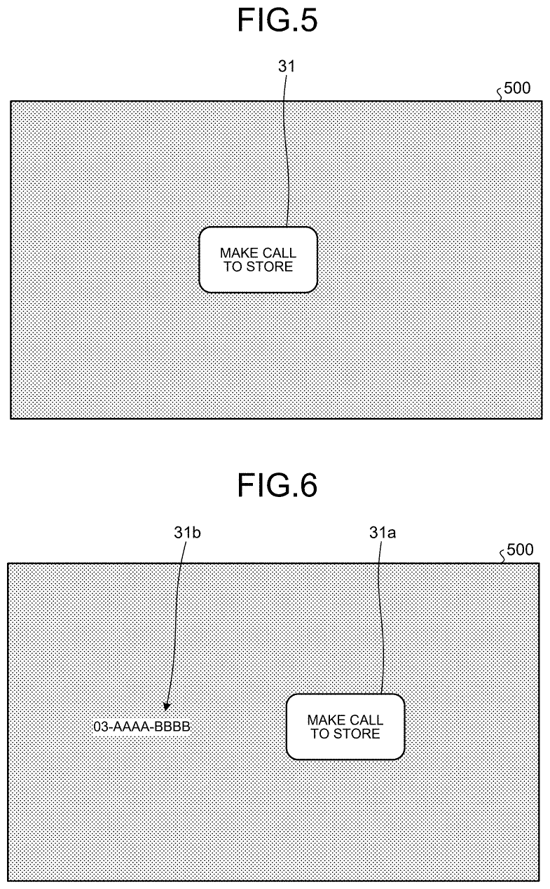

Next, the following describes a screen example of the second image data in the panel unit 4 with reference to FIG. 5 and FIG. 6. FIG. 5 and FIG. 6 are diagrams illustrating the screen example of the second image data in the panel unit 4. A screen 500 illustrated in each of FIGS. 5 and 6 corresponds to the display region of the panel unit 4.

As illustrated in FIG. 5, the second image data is displayed as the icon image data 31 at a predetermined display position on the screen 500. The icon image data 31 symbolizes predetermined processing performed by the onboard system such as the host 10 and the peripheral appliance 100. In the example illustrated in FIG. 5, displayed is the icon image data 31 symbolizing processing of “making a call to a store”.

The display device 1 then drives the electrode 41 in a region corresponding to the display position of the icon image data 31 to enable a touch operation on the icon image data 31. That is, the display device 1 displays the icon image data 31 in part of the display region of the panel unit 4, and determines presence/absence of a touch based on the touch detection signals RX of the electrodes 41 corresponding to at least part of the electrodes 41.

The touch detection signals RX to be received may be the touch detection signals RX of all the electrodes 41, or may be the touch detection signals RX of only part of the electrodes 41 corresponding to the icon image data 31. Specifically, the display device 1 may receive the touch detection signals RX of all the electrodes 41, and determine presence/absence of a touch by selectively using only the touch detection signals RX of part of the electrodes 41 corresponding to the display position of the icon image data 31 among the received touch detection signals RX. Alternatively, the display device 1 may determine presence/absence of a touch by receiving only the touch detection signals RX of part of the electrodes 41 corresponding to the display position of the icon image data 31.

The display device 1 may disable the touch operation on a region other than the icon image data 31 by preventing the electrode 41 in a region other than the region corresponding to the display position of the icon image data 31 from being driven (preventing the touch drive signal TX from being output). Alternatively, the display device 1 may output the touch drive signals TX to all the electrodes 41, and receive the touch detection signal RX from only the electrode 41 corresponding to the display position of the icon image data 31.

In a case that the icon image data 31 of “make call to store” is touched by the user, the peripheral appliance 100 (telephone) performs processing of making a call to the store, and the host 10 performs processing of turning on a microphone and a speaker in the vehicle.

FIG. 5 illustrates a case of displaying only the icon image data 31 as the second image data. Alternatively, for example, also the text data 31b related to the icon image data 31 may be displayed at the same time as illustrated in FIG. 6. In the example illustrated in FIG. 6, a phone number of the store is displayed as the text data 31b.

The touch operation is not required for the text data 31b, so that the display device 1 prevents, from being driven, the electrode 41 in a region corresponding to the display position of the text data 31b.

The icon image data 31a receives the touch operation, so that the icon image data 31a is preferably displayed at a display position and in a display size corresponding to the touch detection region. The touch detection region is a region obtained by dividing one screen into a plurality of regions along boundaries of the electrodes 41. That is, each of the touch detection regions includes at least one of the electrodes 41, and the boundary between the adjacent touch detection regions corresponds to a boundary between the adjacent electrodes 41. The touch detection region is also called a scan block as a unit of reading out the touch detection signal in one touch detection period.

The following describes a division example of the screen 500 with reference to FIG. 7 to FIG. 9. FIG. 7 to FIG. 9 are diagrams illustrating division examples of the screen 500. For example, as illustrated in FIG. 7, the display device 1 divides the screen 500 into four touch detection regions 530a to 530d.

The display device 1 displays the icon image data 31 in the optional touch detection region 530c among the four touch detection regions 530a to 530d. The icon image data 31 is previously stored in the storage unit 3 as information having a display size matching with a region size of each of the touch detection regions 530a to 530d.

With this, the display device 1 can determine only the display position of the icon image data 31 without performing adjustment processing for the display size. The control unit 2 drives the electrode 41 disposed in the touch detection region 530c, in which the icon image data 31 is displayed, to cause the touch detection region 530c to be a touch-enabled region 510.

On the other hand, the control unit 2 prevents the electrodes 41 in the touch detection regions 530a, 530b, and 530d other than the touch detection region 530c from being driven to cause the touch detection regions 530a, 530b, and 530d to be touch-disabled regions 520. As illustrated in FIG. 8, the text data 31b not requiring a touch operation is displayed in the touch-disabled region 520.

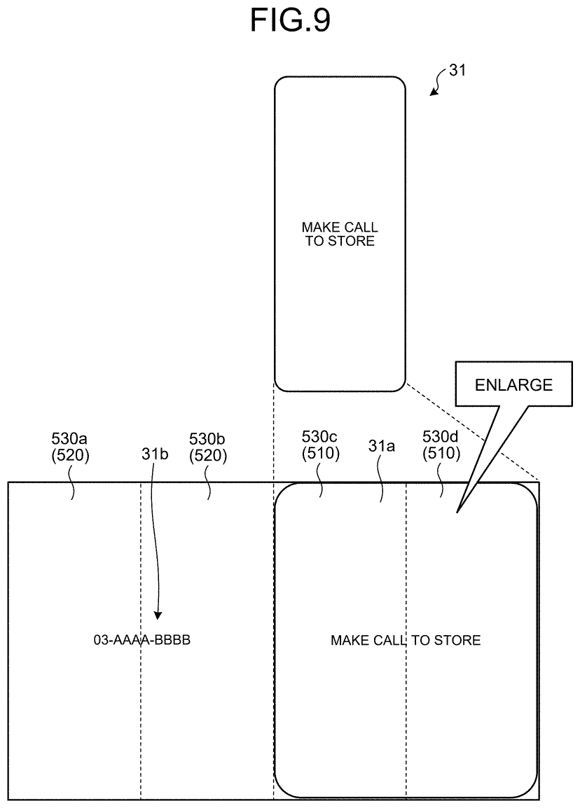

While FIG. 7 and FIG. 8 illustrate a case of displaying the icon image data 31a in the one touch detection region 530c, the embodiment is not limited thereto. For example, the icon image data 31a may be displayed in a plurality of the touch detection regions. The following describes such a point with reference to FIG. 9.

As illustrated in FIG. 9, the control unit 2 may display the icon image data 31a in the two touch detection regions 530c and 530d adjacent to each other. In such a case, the icon image data 31a is stored in the display size corresponding to the one touch detection region, so that the display size is enlarged corresponding to region sizes of the two touch detection regions 530c and 530d.

The control unit 2 drives the electrodes 41 in the two touch detection regions 530c and 530d in which the icon image data 31 is displayed to cause the two touch detection regions 530c and 530d to be touch-enabled regions 510.

On the other hand, the control unit 2 prevents the electrodes 41 in the touch detection regions 530a and 530b other than the touch detection regions 530c and 530d from being driven to cause the touch detection regions 530a and 530b to be the touch-disabled regions 520.

FIG. 7 to FIG. 9 illustrate the division example in which the four touch detection regions 530a to 530d each extend in a vertical direction, and are arranged side by side in a horizontal direction. Alternatively, for example, division may be performed so that the four touch detection regions each extend in the horizontal direction, and are arranged side by side in the vertical direction.

The number of divisions is not limited to four, and may be equal to or smaller than three, or may be equal to or larger than five. The screen 500 may be divided in each of the vertical and horizontal directions. The touch detection regions do not necessarily have the same region size, and the region sizes of the respective touch detection regions may be different from each other in the one screen 500.

As described above, in the present embodiment, in a case that the operation mode is the specific mode, coordinates of the touch position are not required to be calculated so long as the screen 500 is divided into a plurality of regions and presence/absence of a touch can be detected in the touch-enabled region determined in advance among the divided regions, so that a load of arithmetic processing can be reduced. In the present embodiment, in a case of displaying the icon image data in the touch detection region, the coordinates of the touch position are not required to be calculated so long as presence/absence of a touch can be detected in the touch detection region corresponding to the icon image, so that the load of arithmetic processing can be further reduced.

### Second Embodiment

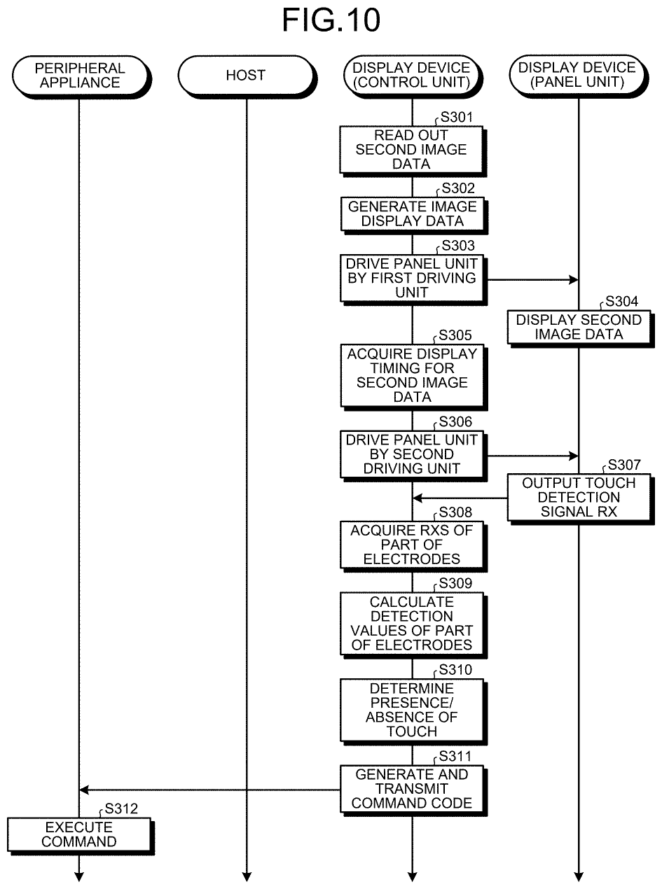

Next, the following describes a second embodiment with reference to FIG. 10. The second embodiment is different from the first embodiment in that, the abnormality in image display is a communication abnormality between the display device 1 and the host 10. Functional configurations of respective devices and operations in the normal mode M1 in the second embodiment are the same as those in the first embodiment, so that description thereof will not be repeated herein. Herein, with reference to FIG. 10, the following describes an operation example in the specific mode M2, which is a difference from the first embodiment.

FIG. 10 is a diagram illustrating an operation example of the display system S according to the second embodiment. As illustrated in FIG. 10, first, the panel control unit 20 reads out the image information 31 as the second image data from the storage unit 3 (Step S301). That is, in the specific mode M2, the second image data, which has been stored in the memory of the display device 1, is read out instead of acquiring the first image data from the host 10.

Subsequently, the panel control unit 20 of the display device 1 generates image display data to be displayed on the panel unit 4 based on the second image data (Step S302).

Subsequently, the first driving unit 21 acquires the image display data from the panel control unit 20, drives the electrode 41 of the panel unit 4 based on the image display data (Step S303), and thereby displays the second image data in the display region of the panel unit 4 (Step S304).

The panel control unit 20 acquires a display timing for the second image data (Step S305), and controls the second driving unit 22 in accordance with the display timing to drive the electrode of the panel unit 4 (Step S306). That is, the second driving unit 22 generates the touch drive signal TX in accordance with control by the panel control unit 20, and supplies the touch drive signal TX to each of the electrodes 41. With this processing, touch detection is enabled to be performed while displaying the second image data.

The panel unit 4 then outputs, to the data detection unit 23, the touch detection signal RX corresponding to the user's operation (Step S307). Subsequently, the data detection unit 23 acquires the touch detection signal RX from part of the electrodes 41 corresponding to the display position of the second image data in the display region of the panel unit 4 (Step S308).

Subsequently, the data detection unit 23 calculates the detection value for each of the part of the electrodes 41 based on the touch detection signal RX (Step S309). Subsequently, the panel control unit 20 determines presence/absence of a touch based on the detection value (Step S310). Specifically, the panel control unit 20 determines that touch is performed (present) in a case that the detection value becomes equal to or larger than the threshold. That is, in the specific mode, only presence/absence of a touch is determined, and the touch position is not calculated.

Subsequently, in a case of determining that touch is performed, the panel control unit 20 directly transmits a command code assigned to the second image data to the peripheral appliance 100 (Step S311). The peripheral appliance 100 then executes a command based on the received command code (Step S312).

That is, as indicated by Step S311, in the second embodiment, a communication abnormality occurs between the display device 1 and the host 10, so that the command code is not transmitted to the host 10 but transmitted to the peripheral appliance 100.

In this way, the display device 1 according to the second embodiment can perform predetermined processing without using the host 10 even in a case that a communication abnormality occurs between the display device 1 and the host 10, so that the occupant can be prevented from being embarrassed with the abnormality of the display device 1. That is, with the control method for the display device 1 according to the embodiment, a sense of security can be given to the occupant even in a case that an image abnormality occurs in the display device 1.

### Third Embodiment

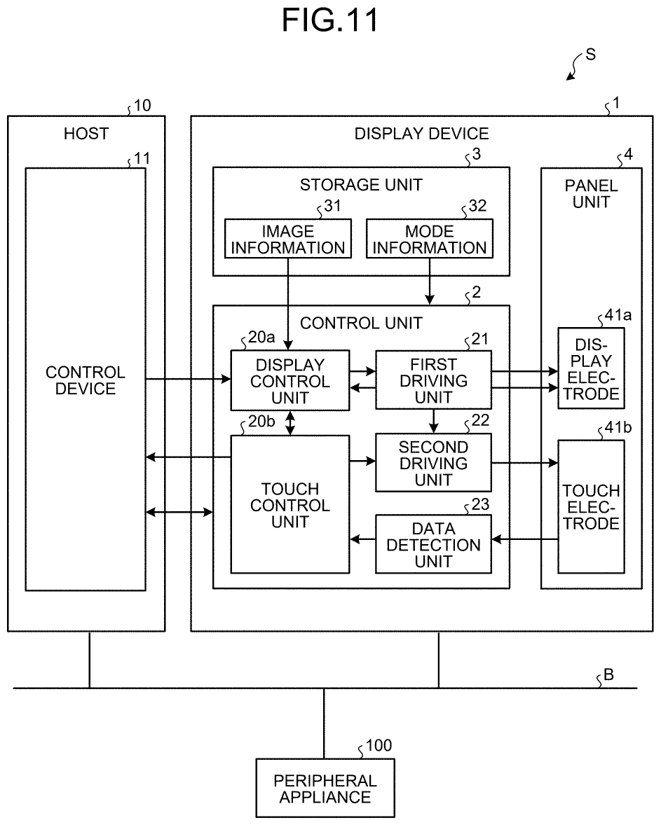

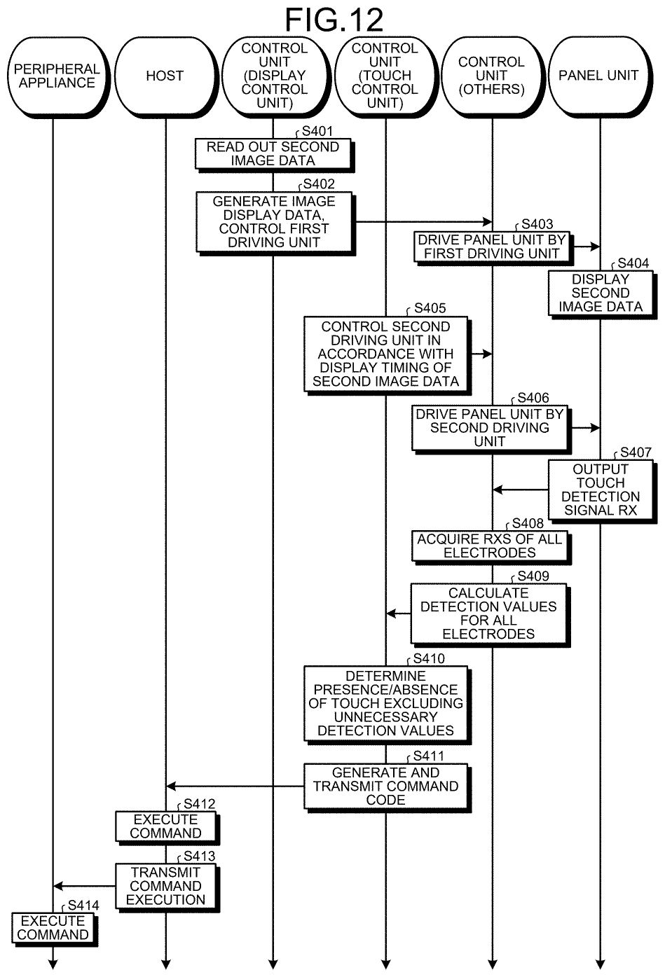

Next, the following describes a third embodiment with reference to FIG. 11 and FIG. 12. The third embodiment is different from the first embodiment in that, while the panel unit 4 of the first embodiment is the in-cell type, the panel unit 4 of the third embodiment is the out-cell type.

FIG. 11 is a block diagram illustrating a configuration example of the display system S according to the third embodiment. In a case of the out-cell type, in the panel unit 4, a display electrode 41a for performing image display and a touch electrode 41b for performing touch detection are independently disposed. In other words, in the panel unit 4, a display panel for performing image display and a touch panel for performing touch detection are independently laminated.

The control unit 2 according to the third embodiment includes a display control unit 20a and a touch control unit 20b in place of the panel control unit 20 according to the first embodiment. The display control unit 20a controls the first driving unit 21. The touch control unit 20b controls the second driving unit 22. In the third embodiment, the display control unit 20a serves a function of controlling the first driving unit 21 among the functions of the panel control unit 20, and the touch control unit 20b serves a function of controlling the second driving unit 22 among the functions of the panel control unit 20.

That is, control of the first driving unit 21 and control of the second driving unit 22 are performed by the panel control unit 20 in a cooperative manner in the first embodiment, whereas, in the third embodiment, control of the first driving unit 21 and control of the second driving unit 22 are independently performed by the display control unit 20a and the touch control unit 20b.

Next, the following describes an operation example of the display system S in the specific mode M2 with reference to FIG. 12. FIG. 12 is a sequence diagram illustrating the operation example of the display system S in the specific mode M2 according to the third embodiment. In FIG. 12, the control unit 2 is partitioned into the “display control unit 20a”, the “touch control unit 20b”, and the “others”. The “others” include the first driving unit 21, the second driving unit 22, and the data detection unit 23.

As illustrated in FIG. 12, first, the display control unit 20a reads out the image information 31 as the second image data from the storage unit 3 (Step S401).

Subsequently, the display control unit 20a generates image display data to be displayed on the panel unit 4 based on the second image data, and controls the first driving unit 21 (Step S402).

Subsequently, the first driving unit 21 drives the display electrode 41a of the panel unit 4 in accordance with control by the display control unit 20a (Step S403) to display the second image data in the display region of the panel unit 4 (Step S404).

The touch control unit 20b acquires a display timing for the second image data from the display control unit 20a, and controls the second driving unit 22 in accordance with the display timing (Step S405) to drive the touch electrode 41b of the panel unit 4 (Step S406). That is, the second driving unit 22 generates the touch drive signal TX in accordance with control by the touch control unit 20b, and supplies the touch drive signal TX to each of the touch electrodes 41b. With this processing, touch detection is enabled to be performed by the touch electrode 41b while the second image data is displayed by the display electrode 41a.

The panel unit 4 then outputs the touch detection signal RX corresponding to the user's operation to the data detection unit 23 (Step S407). Subsequently, the data detection unit 23 acquires the touch detection signals RX from all the touch electrodes 41b (Step S408).

Subsequently, the data detection unit 23 calculates detection values for all the touch electrodes 41b based on the touch detection signals RX (Step S409). Subsequently, the touch control unit 20b determines presence/absence of a touch based on the detection values excluding the detection value for the touch electrode 41b corresponding to a region other than the display position of the second image data, which is an unnecessary detection value (Step S410).

That is, in the specific mode, the data detection unit 23 acquires the touch detection signals RX from the respective touch electrodes 41b, selects the touch detection signal RX of the touch electrode 41b corresponding to a partial display region corresponding to the second image data from among the touch detection signals, and determines presence/absence of a touch based on the selected touch detection signal RX. Therefore, presence/absence of a touch for the second image data can be determined with high accuracy even in a case of the out-cell type.

Subsequently, in a case that it is determined that touch is performed, the touch control unit 20b transmits the command code assigned to the second image data to the host 10 (Step S411). The host 10 then executes the command based on the received command code (Step S412). In a case that the command code includes a command to execute the peripheral appliance 100, the host 10 transmits, to the corresponding peripheral appliance 100, command execution indicating to execute the command (Step S413). The peripheral appliance 100 then executes the command based on the command execution (Step S414).

As described above, the display device 1 according to the first to the third embodiments includes the panel unit 4 and the control unit 2. The panel unit 4 includes the electrodes 41 (including the display electrode 41a and the touch electrode 41b) for respectively performing image display and touch detection. The control unit 2 controls the panel unit 4 in the first mode (normal mode M1) in a case that an abnormality related to image display is not detected, and controls the panel unit 4 in the second mode (specific mode M2) in a case that the abnormality is detected. In the first mode, the control unit 2 displays, on the panel unit 4, the first image data that is acquired from the onboard system (the host 10 and the peripheral appliance 100), calculates the touch position based on the touch detection signal RX acquired from the panel unit 4, and outputs the touch position to the onboard system. In the second mode, the control unit 2 displays, on the panel unit 4, the second image data that is previously stored, determines presence/absence of a touch based on the touch detection signal RX acquired from the panel unit 4, and outputs an execution command to execute predetermined processing to the onboard system in a case that touch is performed. Therefore, a sense of security can be given to the occupant even in a case that an abnormality occurs in image display.

As described above, the display system S according to the first to the third embodiments includes the display device 1 and the host 10. The display device 1 includes the panel unit 4 and the control unit 2. The panel unit 4 includes the electrodes 41 (including the display electrode 41a and the touch electrode 41b) for respectively performing image display and touch detection. The control unit 2 controls the panel unit 4 in the first mode (normal mode M1) in a case that an abnormality related to image display is not detected, and controls the panel unit 4 in the second mode (specific mode M2) in a case that the abnormality is detected. In the first mode, the control unit 2 displays, on the panel unit 4, the first image data that is acquired from the onboard system (the host 10 and the peripheral appliance 100), calculates the touch position based on the touch detection signal RX acquired from the panel unit 4, and outputs the touch position to the onboard system. In the second mode, the control unit 2 displays, on the panel unit 4, the second image data that is previously stored, determines presence/absence of a touch based on the touch detection signal RX acquired from the panel unit 4, and outputs an execution command to execute predetermined processing to the onboard system in a case that touch is performed. Therefore, a sense of security can be given to the occupant even in a case that an abnormality occurs in image display.

Modification

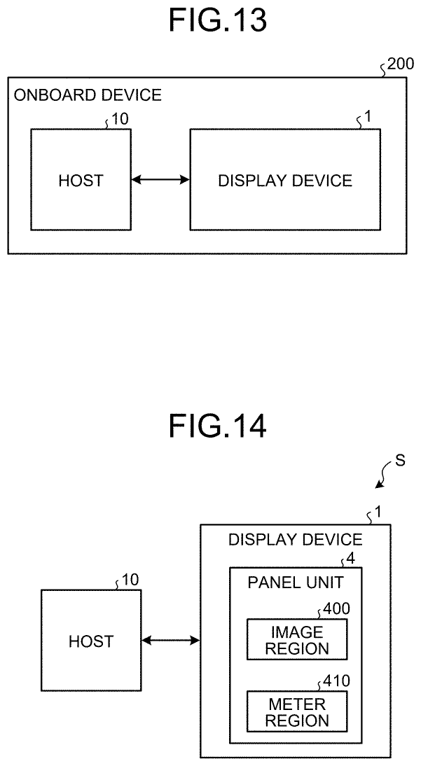

In addition to the embodiments described above, configurations as illustrated in FIG. 13 and FIG. 14 may be employed depending on a product form. FIG. 13 is a diagram illustrating a configuration example of an onboard device 200 according to a modification. FIG. 14 is a diagram illustrating a configuration example of the display system S according to the modification.

For example, as illustrated in FIG. 13, the onboard device 200 may be configured by integrating the host 10 and the display device 1. As illustrated in FIG. 14, the display device 1 may also be used as a meter. Specifically, the panel unit 4 of the display device 1 includes an image region 400 in which the first image data and the second image data are displayed, and a meter region 410 in which the meter is displayed.

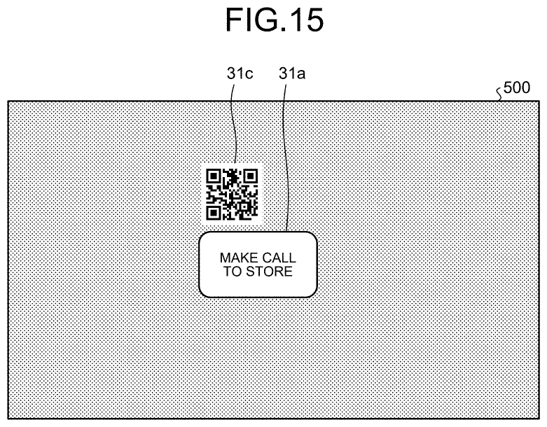

In addition to the screen examples according to the embodiments described above, for example, a screen example as illustrated in FIG. 15 may be employed. FIG. 15 is a diagram illustrating a screen example according to the modification. As illustrated in FIG. 15, an information code 31c such as a two-dimensional bar code may be displayed together with the icon image data 31a. Information related to the icon image data 31a (details such as a phone number and an address of the store) is embedded in the information code 31c. The information code 31c is not limited to the two-dimensional bar code, and an optional code can be employed so long as the information can be embedded therein.

In this way, by displaying the information code 31c at the same time, contact can be made to the store from a terminal of the occupant via the information code 31c in addition to a case of making contact with the store via a touch operation on the icon image data 31a. That is, redundancy can be given to action of the occupant at the time when an abnormality occurs in image display.

The computer program for performing the various kinds of processing in the embodiments described above has a module configuration including the respective functional units described above. As actual hardware, for example, when a CPU (processor circuit) reads out and executes an information processing program from a ROM or an HDD, each of the functional units described above is loaded into a RAM (main memory), and each of the functional units described above is generated on the RAM (main memory). Part or all the functional units described above can be implemented by using dedicated hardware such as an application specific integrated circuit (ASIC) or a field-programmable gate array (FPGA).

While certain embodiments have been described above, these embodiments have been presented by way of example only, and are not intended to limit the scope of the present disclosure. Indeed, the novel embodiments described above can be embodied in a variety of other forms; furthermore, various omissions, substitutions and changes in the form of the embodiments described herein can be made without departing from the spirit of the invention. The accompanying claims and their equivalents are intended to cover the embodiments described above as would fall within the scope and spirit of the present disclosure.

The present disclosure includes a display system comprising the following configuration supported by the embodiments and the modification described above. The display system includes an onboard system and a display device. The onboard system includes a host device and a peripheral appliance. The display device includes a hardware processor and a memory. The panel device includes a plurality of electrodes to perform image display and touch detection. The hardware processor controls the panel device in a first mode for displaying first image data, and controls the panel device in a second mode for displaying second image data in a case that an abnormality in display of the first image data is detected. The memory stores the second image data. The hardware processor is configured to, in the first mode, acquire the first image data from an external system, display the first image data on the panel device, calculate a touch position on the panel device based on a touch detection signal acquired from the panel device, and output the touch position to the external system. The hardware processor is configured to, in the second mode, read out the second image data from the memory, display the second image data on the panel device in place of the first image data, determine presence or absence of a touch on the panel device based on a touch detection signal acquired from the panel device, and output, to the external system, an execution command to execute predetermined processing in response to determining that the touch on the panel device is present.

The display device and the control method for the display device according to the present disclosure are each able to present, to the occupant, required information by displaying the second image data on the display device even in a case that an abnormality occurs in display of the first image data. Therefore, a sense of security can be given to the occupant.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A display device comprising:
a panel device including a plurality of electrodes to perform image display and touch detection;
a hardware processor that controls the panel device in a first mode for displaying first image data, and controls the panel device in a second mode for displaying second image data in a case that an abnormality in display of the first image data is detected; and
a memory that stores the second image data, wherein
the hardware processor is configured to, in the first mode,
acquire the first image data from an external system,
display the first image data on the panel device,
calculate a touch position on the panel device based on a touch detection signal acquired from the panel device, and
output the touch position to the external system, and
the hardware processor is configured to, in the second mode,
read out the second image data from the memory,
display the second image data on the panel device in place of the first image data,
determine presence or absence of a touch on the panel device based on a touch detection signal acquired from the panel device, and
output, to the external system, an execution command to execute predetermined processing in response to determining that the touch on the panel device is present.

2. The display device according to claim 1, wherein
the second image data includes icon image data symbolizing the predetermined processing, and
the hardware processor is configured to, in the second mode,
display the icon image data in a partial display region of the panel device, and
determine the presence/absence of a touch based on the touch detection signal of an electrode corresponding to at least the partial display region among the plurality of electrodes.

3. The display device according to claim 2, wherein the hardware processor is configured to, in the second mode,
acquire the touch detection signal from the electrode corresponding to the partial display region among the plurality of electrodes, and
determine the presence/absence of a touch based on the acquired touch detection signal.

4. The display device according to claim 2, wherein the hardware processor is configured to, in the second mode,
acquire the touch detection signal from each of the plurality of electrodes,
select the touch detection signal of the electrode corresponding to the partial display region from among the acquired touch detection signals, and
determine the presence/absence of a touch based on the selected touch detection signal.

5. The display device according to claim 1, wherein the plurality of electrodes are shared to perform the image display and the touch detection.

6. The display device according to claim 4, wherein the plurality of electrodes include a first electrode used for the image display and a second electrode used for the touch detection, the first and second electrodes being disposed independently of each other.

7. The display device according to claim 1, wherein the hardware processor is configured to control the panel device in the second mode when the first image data is abnormal or when communication with the external system is abnormal.

8. The display device according to claim 7, wherein
the external system includes a host device and a peripheral appliance, and
the hardware processor is configured to output the execution command to the host device in a case that the first image data is abnormal.

9. The display device according to claim 7, wherein
the external system includes a host device and a peripheral appliance, and
the hardware processor is configured to output the execution command to the peripheral appliance in a case that communication with the external system is abnormal.

10. A control method implemented by a computer of a display device in which a panel device is provided, the panel device including a plurality of electrodes to perform image display and touch detection, the control method comprising:
controlling the panel device in a first mode for displaying first image data; and
controlling the panel device in a second mode for displaying second image data in a case that an abnormality in display of the first image data is detected, wherein,
the controlling the panel device in a first mode includes
acquiring the first image data from an external system,
displaying the first image data on the panel device,
calculating a touch position on the panel device based on a touch detection signal acquired from the panel device, and
outputting the touch position to the external system, and
the controlling the panel device in a second mode includes
reading out the second image data from a memory of the display device,
displaying the second image data on the panel device in place of the first image data,
determining presence or absence of a touch on the panel device based on a touch detection signal acquired from the panel device, and
outputting, to the external system, an execution command to execute predetermined processing in response to determining that the touch on the panel device is present.

11. The display device according to claim 1, wherein
the panel device and the hardware processor are installed in a vehicle, and
the external system is an onboard system of the vehicle.
